(19) United States
(12) Patent Application Publication
(10) Pub. No.: US 2015/0323799 A1
(43) Pub. Date: Nov. 12, 2015

(54) LIGHT BEAM FORMATTER AND METHOD FOR FORMATTING A LIGHT BEAM

(71) Applicant: OSELA INC., Montreal (CA)

(72) Inventor: Francis Cayer, Saint-Eustache (CA)

(21) Appl. No.: 14/706,558

(22) Filed: May 7, 2015

Related U.S. Application Data
(60) Provisional application No. 61/989,735, filed on May 7, 2014.

(51) Int. Cl. G02B 27/09; G02B 27/00

(52) U.S. Cl. CPC G02B 27/0927; G02B 27/095; G02B 27/0944; G02B 27/0025

(57) ABSTRACT

The light beam formatter for formatting a light beam having a first mode field diameter and a first intensity profile having a non-uniformly distributed energy density, the light beam formatter generally has a housing having an optical path for the light beam; first and second optical elements mounted to the housing and optically coupled to the optical path and spaced from each other by a distance along the optical path, the first optical element and the second optical element being adapted to format the first mode field diameter of the light beam to a second mode field diameter, and a beam uniformizing element mounted to the housing and optically coupled to the optical path between the first optical element and the second optical element, the beam uniformizing element being adapted to uniformize the first intensity profile of the light beam into a second intensity profile.

### CROSS-REFERENCE TO RELATED APPLICATIONS

This application claims priority of U.S. provisional application No. 61/989,735, filed May 7, 2014, by applicant, the contents of which is hereby incorporated by reference.

### FIELD

The improvements generally relate to the field of formatting and/or modifying an intensity profile of a light beam, and more particularly to the field of uniformity-formatting of an intensity profile of a laser beam.

### BACKGROUND

Material processing and high-tech manufacturing applications often require to deliver an amount of energy on a certain area. To do so, light beam generators were considered useful as they can provide a collimated light beam that can be focused at a focal point to project an intensity profile on an energy receiving area. Many light sources initially have a Gaussian intensity profile which is then uniformized into a top-hat or overcorrected intensity profile prior to delivering it to the target. This can be achieved using a uniformizing optical element (e.g. an aspherical optical element).

The uniformity of the intensity profile of the focused light beam may depend concurrently on at least on two parameters: a mode field diameter of the collimated light beam upstream of the aspherical optical element and on specifications of the aspherical optical element itself. Since typical manufacturing processes for an aspherical optical elements have limited precision, the is a challenge is satisfying both parameters. In another aspect, there was a need for providing more compact light beam formatters. There thus remained room for improvement.

### SUMMARY

There is provided a light beam formatter and/or modifier for formatting an incoming light beam having a first intensity profile which has a somewhat Gaussian intensity profile to an outgoing light beam having a second intensity profile which has a uniformized intensity profile (it will be understood in this specification that the expressions “uniformized” and “uniformly distributed” does not correspond to a theoretically perfect profile, but rather to a practical profile being significantly more uniform than a Gaussian profile). Such a light beam formatter is obtained by providing a beam uniformizing element, such as an aspherical optical element or a diffractive optical element (DOE), along an optical path between optical elements of an arrangement typically referred to as a beam expander or a beam contractor. Accordingly, notwithstanding the mode field diameter of the incoming light beam, the light beam formatter can format or tune the second intensity profile of the outgoing light beam by moving the beam uniformizing element along the optical path between the optical elements of the beam expander or the beam contractor.

In accordance with one aspect, there is provided a light beam formatter comprising a first optical element and a second optical element spaced from one another along an optical path and cooperating to one of expand and contract a mode field diameter of a light beam travelling along the optical path, across and from the first optical element to and across the second optical element; and a beam uniformizing element positioned between the first optical element and the second optical element in the optical path.

In accordance with another aspect, there is provided a light beam formatter for formatting a light beam having a first mode field diameter and a first intensity profile having a non-uniformly distributed energy density, the light beam formatter comprising: a housing having an optical path for the light beam; a first optical element mounted to the housing and optically coupled to the optical path; a second optical element mounted to the housing and optically coupled to the optical path and spaced from the first optical element by a distance along the optical path, the first optical element and the second optical element being adapted to format the first mode field diameter of the light beam to a second mode field diameter, the second mode field diameter being different from the first mode field diameter; and a beam uniformizing element mounted to the housing and optically coupled to the optical path between the first optical element and the second optical element, the beam uniformizing element being adapted to uniformize the first intensity profile of the light beam into a second intensity profile.

In accordance with another aspect, there is provided a method for formatting an intensity profile of a light beam, the method comprising the steps of: propagating the light beam along an optical path, the light beam having a first intensity profile and a first mode field diameter; formatting the mode field diameter of the light beam from the first mode field diameter to a second mode field diameter, said formatting occurring along a length of the optical path; providing a beam uniformizing element optically coupled to the optical path along the length of the optical path, at a position along the length thereof; and formatting the light beam from the first intensity profile to a second intensity profile by displacing the beam uniformizing element along the length of the optical path.

Many further features and combinations thereof concerning the present improvements will appear to those skilled in the art following a reading of the instant disclosure.

### DESCRIPTION OF THE FIGURES

In the figures,

FIG. 1A is a schematic view of a first example of a light beam formatter;

FIG. 1B is an example of an intensity profile of a collimated light beam generated by a light beam generator and impinging into the light beam formatter of FIG. 1A;

FIG. 1C is an example of a top-hat intensity profile of a light beam exiting the light beam formatter of FIG. 1A;

FIG. 2A is a schematic view of the light beam formatter of FIG. 1A in a different configuration;

FIG. 2B is an example of an undercorrected intensity profile of a light beam exiting the light beam formatter in the configuration of FIG. 2A;

FIG. 3A is a schematic view of the light beam formatter of FIG. 1A in another different configuration;

FIG. 3B is an example of an overcorrected intensity profile of a light beam exiting the light beam formatter in the configuration of FIG. 3A;

FIG. 4A is a schematic view of a second example of a light beam formatter;

FIG. 4B is a schematic view of a third example of a light beam formatter;

FIG. 4C is an example of a top-hat intensity profile of a light beam exiting the light beam formatter of FIGS. 4A and 4B; and

FIG. 5 shows a graph of a plurality of intensity profiles as a function of an axis transverse to an optical path for the same light beam formatter in different configurations.

### DETAILED DESCRIPTION

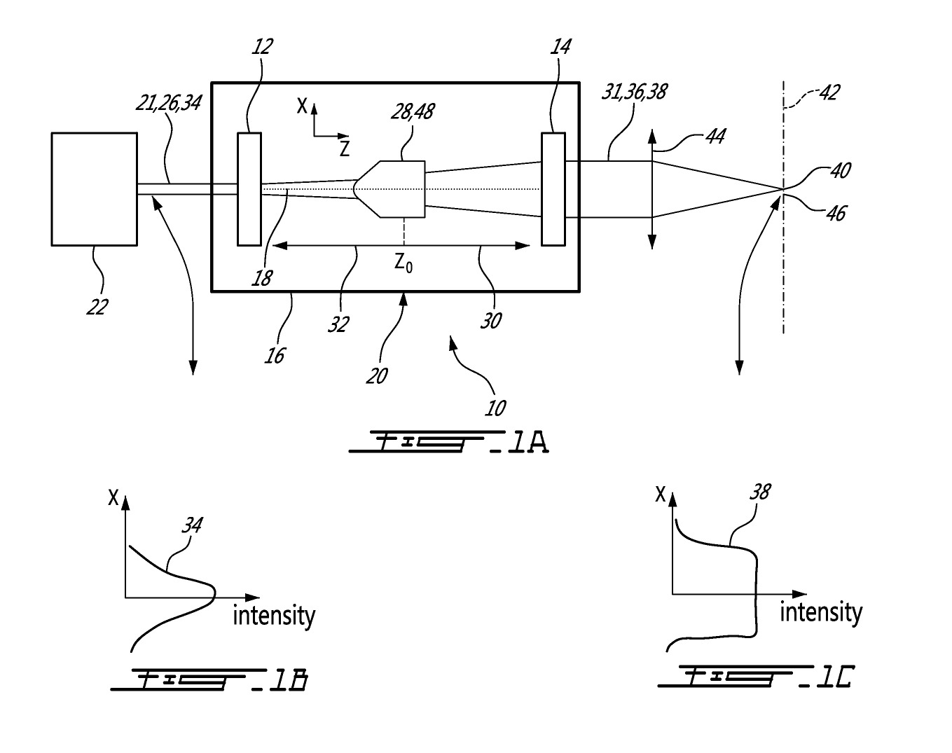

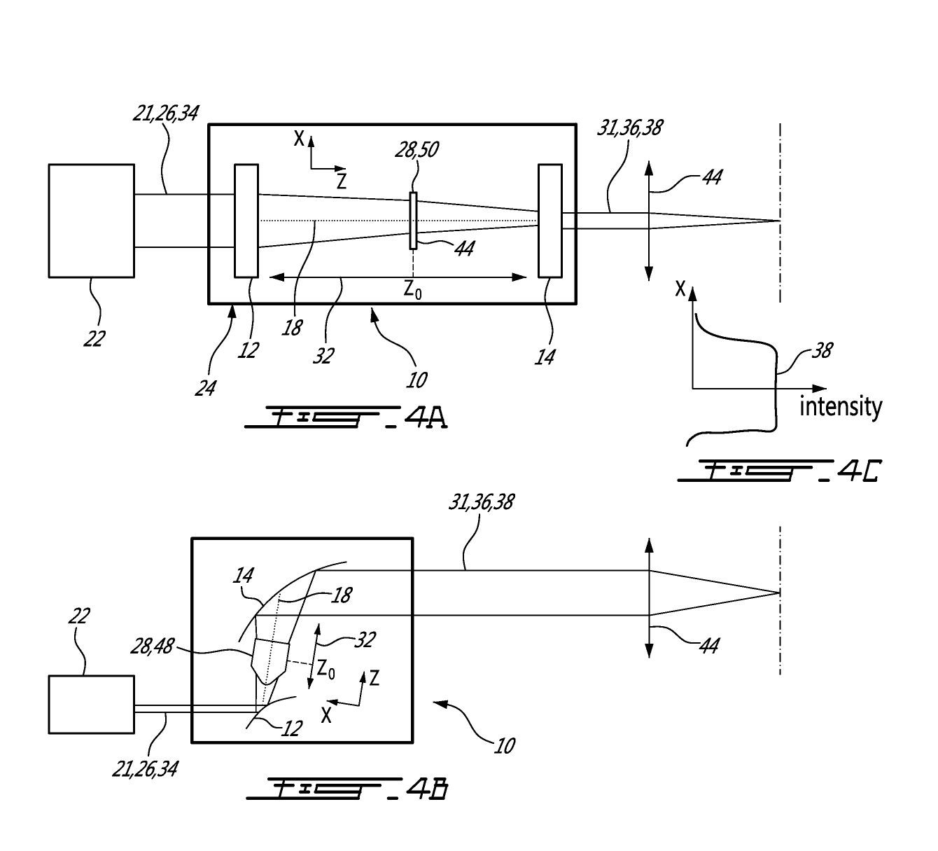

FIG. 1A is a schematic view of a first example of a light beam formatter 10. The light beam formatter 10 generally has a first optical element 12 and a second optical element 14 mounted to a frame 16 and spaced from one another along an optical path 18 and acting as a light beam expander 20 (e.g. telescope) when an incoming light beam 21 generated by a light beam generator 22 impinges the light beam formatter 10 along the optical path 18 along the z axis. An alternate configuration where the optical elements 12, 14 act as a light beam contractor 24 (see FIG. 4A) will be detailed further below with reference to FIG. 4A. Indeed, the first optical element 12 and second optical element 14 can cooperate so as to expand and/or contract a first mode field diameter 26 of the incoming light beam 21 propagating along the optical path 18, across and from the first optical element 12 to and across the second optical element 14.

It was found advantageous to movably mount a beam uniformizing element 28 on the frame 16, between the first optical element 12 and the second optical element 14 in the optical path 18 so as to be movable along a length 30 of the optical path 18. By doing so, the beam uniformizing element 28 can allow formatting and/or tuning of the uniformity of the intensity distribution (referred to as the intensity profile) of an outgoing light beam 31 exiting the second optical element 14. In this example, the beam uniformizing element 28 is mounted to the frame 16 via a slidable mount 32 which can slide the beam uniformizing element 28 along the length 30 of the optical path 18. The slidable mount 32 can have an actuator (not shown) which allows a user to adjust the beam uniformizing element 28 along the optical path 18. As will be understood, in FIG. 1A, the longitudinal position of the beam uniformizing element 28 along the optical path 18 is adapted to increase the uniformity of the intensity profile of the incoming Gaussian intensity profile of FIG. 1B into a ‘top hat’ intensity profile shown in FIG. 1C, for instance.

More particularly, in the general context of this specification, the light beam entering the light beam formatter 10 (also referred to as the incoming light beam 21) has the first mode field diameter 26 and a first intensity profile 34, while the light beam exiting the light beam formatter 10 (also referred to as the outgoing light beam 31) has a second mode field diameter 36 and a second intensity profile 38. The intensity profile of the incoming light beam or the outgoing light beam 31 represent the energy/intensity profile along an axis transverse to the light beam and identified in the figures as the x axis. For the typical light beam generator 22, the first intensity profile 34 may have a non-uniformized distribution, such as the Gaussian intensity profile of FIG. 1B, along the x axis. Moreover, the second intensity profile 38 may be measured as the outgoing light beam 31 is focused on a focal point 40 disposed on a focal plane 42 using a focusing element 44, the focal plane having an energy receiving area 46 thereon.

It can be seen that the beam uniformizing element 28 is positioned at a position z₀ along the optical path 18 (and along the z axis) and between the first optical element 12 and second optical element 14. Although the beam uniformizing element 28 is movable along the optical path 18, the beam uniformizing element 28 can be specifically positioned at the position z₀ among a plurality of positions zᵢ in order to optimize the uniformity of the intensity profile 38 such as the top-hat intensity profile shown in FIG. 1C. Indeed, FIG. 1C shows the second intensity profile 38 of the outgoing light beam 31 relative to the axis x when the beam uniformizing element 28 is positioned at the position z₀ along the optical path 18.

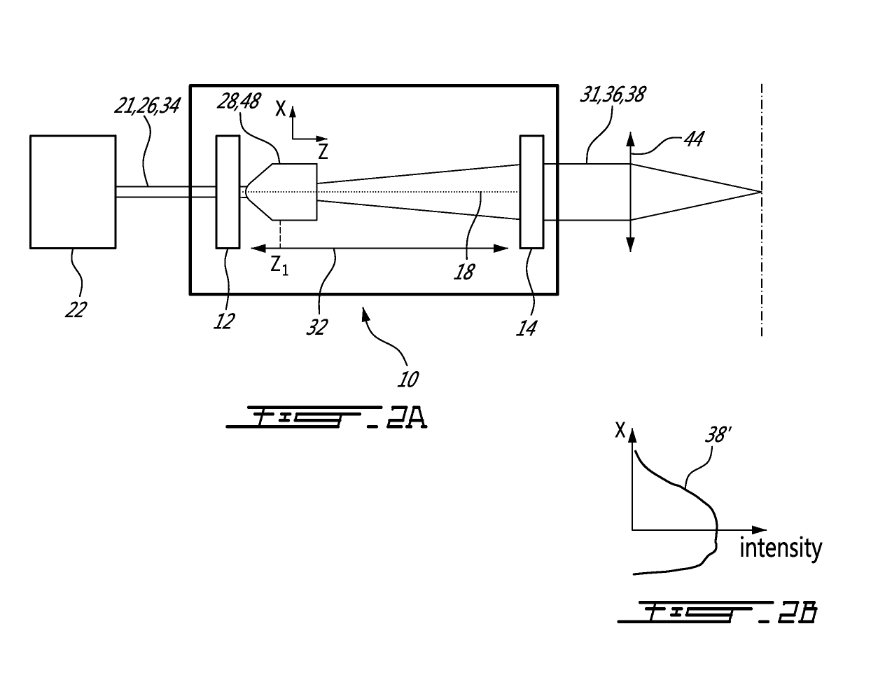

FIG. 2A is a schematic view of the first example of the light beam formatter 10 in a second configuration where the beam uniformizing element 28 is at a position z₁ which is positioned upstream from the position z₀ (shown in FIG. 1A) along the optical path 18. Consequently, the second intensity profile 38 of the outgoing light beam 31, as shown in FIG. 2B, can have a uniformized intensity profile exhibiting an undercorrected intensity profile 38′.

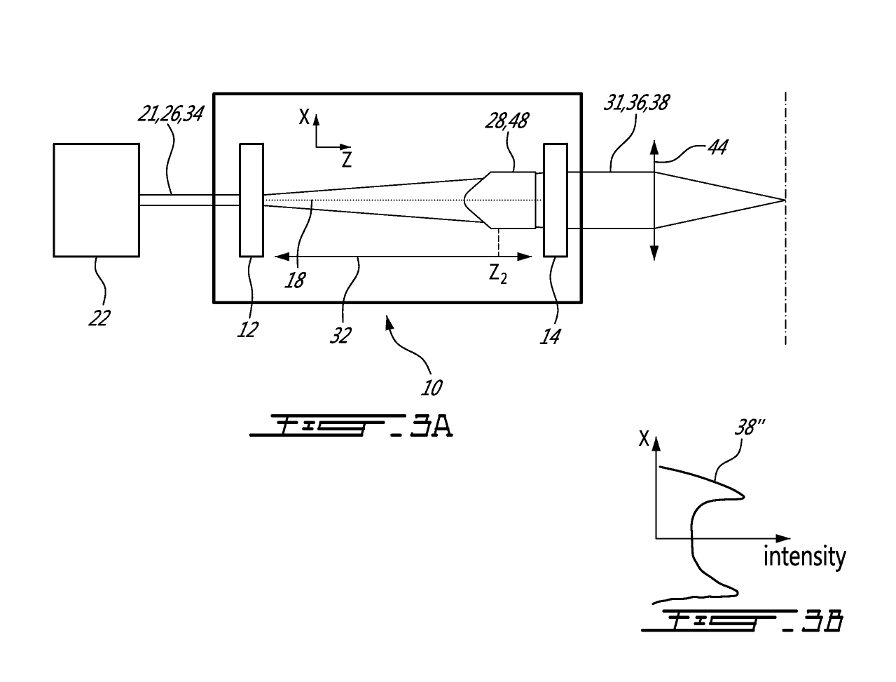

FIG. 3A shows a schematic view of the first example of the light beam formatter in a third configuration which is different from both the first and second configurations. Indeed, in this configuration, the beam uniformizing element 28 is positioned at a position z₂ which is downstream from the position z₀ (shown in FIG. 1A) along the optical path 18. Accordingly, the second intensity profile 38 of the outgoing light beam 31, as shown in FIG. 3B, can have a uniformized intensity profile exhibiting an overcorrected intensity profile 38″. In this case, the second intensity profile 38″ exhibits two distinct peaks of intensity along the transverse x axis.

As set forth in FIGS. 1A, 2A and 3A, the position at which the beam uniformizing element 28 is positioned along the optical path 18 between the first optical element 12 and the second optical element 14 can be adjusted (tuned) in order to obtain a second intensity profile 38 which is different from the first intensity profile 34. In an application where the outgoing light beam 31 having a top hat intensity profile (or flat top) is required, the beam uniformizing element 28 can be positioned at the position z₀. The position z₀ may change depending on the light beam generator 22 and on the first mode field diameter 26 of the incoming light beam 21 for instance. Accordingly, the light beam formatter 10 can be configured to provide an outgoing light beam 31 having the top hat intensity profile of FIG. 1C by adjusting the longitudinal position of the beam uniformizing element 28 along the optical path 18. Although applications requiring a top-hat intensity profile are more frequent, some applications may require an overcorrected intensity profile. In microscopy, for instance, an overcorrected intensity profile 38″ can be used to overcome aberrations such as field curvature which can be found in imaging devices.

Henceforth, although a fixedly set longitudinal position of the beam uniformizing element can be satisfactory in some embodiments, positioning the beam uniformizing element 28 on the slidable mount 32 can be advantageous in some other embodiments, especially where it is desired to use a same light beam reformatter with different light beam generators. More specifically, the first mode field diameter can vary from one light beam generator to the other, the light beam formatter can be used with different light beam generators as the movement of the beam uniformizing element along the optical path can change or adapt the second intensity profile to a desired intensity profile. Thus, the light beam formatter is a simple and practical way to provide an outgoing beam having a desired intensity profile notwithstanding the light beam generator used. The light beam formatter can thus be well suited to use in applications having differing light beam generators since the adjustability of the beam uniformizing element can compensate for the differing first mode field diameters of such differing light beam generators.

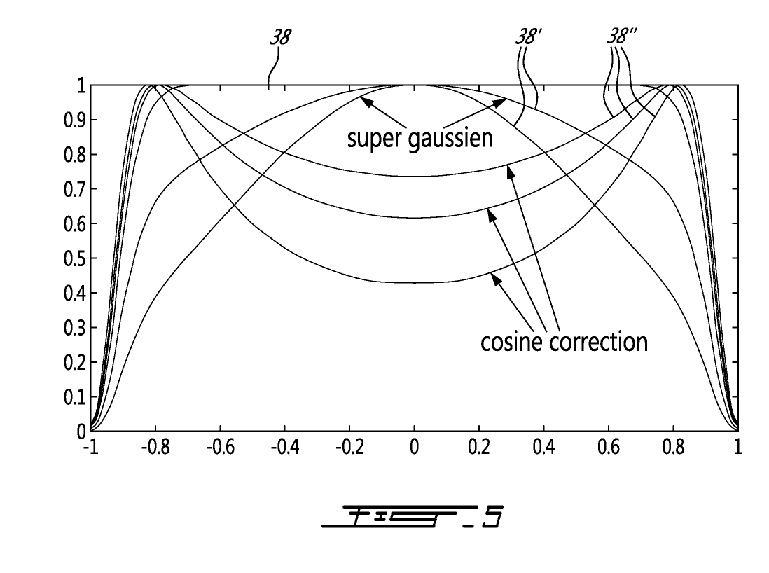

It may be appreciated by one skilled in the art that the beam uniformizing element 28 can be provided in various forms. While in some light beam formatters 10 the beam uniformizing element 28 may be provided in the form of an aspherical optical element 48 (see the beam uniformizing element 28 in FIGS. 1 to 4), it can also be provided in the form of a diffractive optical element 50 (see the beam uniformizing element 28 in FIG. 5), to name another example. Indeed, the aspherical optical element 48 can be a single aspherical lens or in a kit of aspherical lenses coupled one to the other. Indeed, the aspherical optical element 48 of the light beam formatter 10 may include any optical element that can aspherically refract a light beam. For instance, the aspherical optical element 48 can be provided in the form of a combination of two acylindrical lenses (not shown) wherein each of the two acylindrical lenses aspherically refracts light along a transverse axis orthogonal one to the other. In other words, one acylindrical lens of the combination can aspherically refract light along the x axis while the other one acylindrical lens of the combination can aspherically refract light along the y axis, for instance.

Moreover, some applications may need to format the second intensity profile of the outgoing light beam along only one of two orthogonal transverse axes x and y (the latter not being shown). To do so, the beam uniformizing element can be provided in the form of an acylindrical lens or in the form of a kit of acylindrical lenses (not shown) which aspherically refract light only along either the x or the y axis, for instance.

It is further noted that the first optical element and the second optical element are cooperating one with the other to form either a light beam expander or a light beam contractor. However, many combinations of first optical element and second optical element can provide such a result. For instance, these optical elements can be refractive element such as converging or diverging element (lens) or reflective elements such as concave and convex element (mirror).

Accordingly, in one embodiment, the light beam expander can have a first optical element provided in the form of a refractive diverging element and a second optical element provided in the form of either a refractive converging element or a reflective concave element. Alternatively, in another embodiment, a light beam expander can have a first optical element provided in the form of a reflective concave element and a second optical element provided in the form of either a refractive diverging element or a reflective convex element. Moreover, a light beam contractor can have a first optical element provided in the form of a refractive converging element and a second optical element provided in the form of either a refractive diverging element or a reflective convex element. Alternatively, a light beam contractor can have a first optical element provided in the form of a reflective convex element and a second optical element provided in the form of either a refractive converging element or a reflective concave element.

FIGS. 4A and 4B show respectively a second example and a third example of a light beam formatter 10 where the beam uniformizing element 28 is at a position referred to as z₀ and being associated to a top-hat intensity profile shown in FIG. 4C. As it can be seen, FIG. 4A presents a light beam formatter 10 having a light beam contractor 24 having a first optical element 12 provided in the form of a refractive converging element and a second optical element 14 provided in the form of a refractive diverging element. Moreover, the light beam formatter 10 has a beam uniformizing element 28 provided in the form of a diffractive optical element 50. The diffractive optical element 50 can be etched on a substrate 52 such as a glass slide, for instance.

Also, FIG. 4B presents a light beam formatter 10 having a light beam expander 20 having a first optical element 12 provided in the form of a reflective convex element and a second optical element 14 provided in the form of a reflective concave element. In this example, the beam uniformizing element 28 is positioned at the position z₀ and the outgoing light beam 31 can have a flat top intensity profile like the one shown at FIG. 4C. In this last example, it can be seen that the optical path 18 along the z axis may not be parallel to the propagation axis of either the incoming light beam 21 or the outgoing light beam 31. Still, the beam uniformizing element 28 can be positioned along the z axis, between the first and second optical elements 12, 14, at a position to obtain an outgoing light beam 31 having a second intensity profile which is a flat top intensity profile as shown in FIG. 4C.

FIG. 5 shows examples of the second intensity profile 38 that can be obtained when moving (tuning) the beam uniformizing element 28 along the optical path 18, between the first optical element 12 and the second optical element 14. Indeed, one can obtain a second intensity profile 38 having the overcorrected intensity profile 38″ (cosine correction) or the undercorrected intensity profile 38′ (Super-Gaussian) along with a nearly top hat intensity profile 38. The shape pertaining to the second intensity profile, I₂(x), can be given by:

$${I}_{2} ( x ) = \frac{{e}^{- {x}^{n}}}{{cos}^{m} ( x )} ; \qquad ( 1 )$$

wherein n is an even integer and m is a positive real number. To obtain a second intensity profile between the undercorrected intensity profile 38′ (Super Gaussian) and the top hat intensity profile 38, one can set 4<n<100 and m=0. Alternatively, to obtain a second intensity profile between the top hat intensity profile 38 and the overcorrected intensity profile 38″ (cosine correction), one can set n=100 and 0<m<3.

Furthermore, it is noted that any of the first optical element 12, the second optical element 14 and the beam uniformizing element 28 may be adapted to compensate for optical aberrations such as distortion, coma, astigmatism, chromatic aberration, and/or tilt, for instance.

As can be understood, the examples described above and illustrated are intended to be exemplary only. It is readily understood that the light beam can be composed of Light Amplified by Stimulated Emission of Radiation (laser). Moreover, the light beam may be any suitable beam of electromagnetic radiation such as microwave, visible light or infrared (near, mid, far) radiation. The scope is indicated by the appended claims.

What is claimed is:

1. A light beam formatter for formatting a light beam having a first mode field diameter and a first intensity profile having a non-uniformly distributed energy density, the light beam formatter comprising:
a housing having an optical path for the light beam;
a first optical element mounted to the housing and optically coupled to the optical path;
a second optical element mounted to the housing and optically coupled to the optical path and spaced from the first optical element by a distance along the optical path, the first optical element and the second optical element being adapted to format the first mode field diameter of the light beam to a second mode field diameter, the second mode field diameter being different from the first mode field diameter; and
a beam uniformizing element mounted to the housing and optically coupled to the optical path between the first optical element and the second optical element, the beam uniformizing element being adapted to uniformize the first intensity profile of the light beam into a second intensity profile.

2. The light beam formatter of claim 1, wherein the second intensity profile is one of a top-hat intensity profile, and an overcorrected intensity profile.

3. The light beam formatter of claim 1, wherein the second intensity profile (I₂) has a shape varying along an axis x transverse to the optical path in a manner defined by:
$${I}_{2} ( x ) = \frac{{e}^{- {x}^{n}}}{{cos}^{m} ( x )} ;$$
wherein n is an even integer and m is a positive number.

4. The light beam formatter of claim 3, wherein the second intensity profile is an undercorrected intensity profile when 4<n<100 and m=0 and wherein the second intensity profile is an overcorrected intensity profile when n=100 and 0<m<3.

5. The light beam formatter of claim 1, wherein the beam uniformizing element is mounted to the housing via a slidable mount operable to adjust the position of the beam uniformizing element along the optical path.

6. The light beam formatter of claim 5, wherein adjusting the position of the beam uniformizing element allows to change the second intensity profile to one of an undercorrected intensity profile, a top-hat intensity profile, and an overcorrected intensity profile.

7. The light beam formatter of claim 1, wherein the beam uniformizing element is an aspherical refractive element.

8. The light beam formatter of claim 7, wherein the aspherical refractive element comprises a first acylindrical refractive element and a second acylindrical refractive element, the first acylindrical refractive element aspherically refracting the light beam along a first axis transverse to the optical path and the second acylindrical refractive element aspherically refracting the light beam along a second axis transverse to both the first axis and the optical path.

9. The light beam formatter of claim 1, wherein the beam uniformizing element is an acylindrical refractive element.

10. The light beam formatter of claim 1, wherein the beam uniformizing element is a diffractive optical element.

11. The light beam formatter of claim 8, wherein the diffractive optical element is etched on a substrate.

12. The light beam formatter of claim 1, wherein the first optical element is a diverging optical element and the second optical element is a converging optical element.

13. The light beam formatter of claim 1, wherein the first optical element is a converging optical element and the second optical element is a diverging optical element.

14. The light beam formatter of claim 1, wherein at least one of the first optical element, the second optical element and the beam uniformizing element is adapted to compensate for optical aberrations.

15. A method for formatting an intensity profile of a light beam, the method comprising the steps of:
propagating the light beam along an optical path, the light beam having a first intensity profile and a first mode field diameter;
formatting the mode field diameter of the light beam from the first mode field diameter to a second mode field diameter, said formatting occurring along a length of the optical path;
providing a beam uniformizing element optically coupled to the optical path along the length of the optical path, at a position along the length thereof; and
formatting the light beam from the first intensity profile to a second intensity profile with the beam uniformizing element.

16. The method of claim 15 further comprising adjusting the second intensity profile to one of a top-hat intensity profile and an overcorrected intensity profile by adjusting the longitudinal position of the beam uniformizing element along the length of the optical path.

17. The method of claim 16, wherein the step of adjusting the longitudinal position includes sliding the beam uniformizing element using a slidable mount.

18. A light beam formatter comprising a first optical element and a second optical element spaced from one another along an optical path and cooperating together in expanding or contracting a mode field diameter of a light beam travelling along the optical path, across and from the first optical element to and across the second optical element; and a beam uniformizing element positioned between the first optical element and the second optical element in the optical path.

19. The light beam formatter of claim 18, wherein the beam uniformizing element is movably mounted to the light beam formatter so as to be displaceable along the optical path to allow tuning the uniformity of the intensity distribution of the light beam exiting the second optical element.

20. The light beam formatter of claim 19, wherein the beam uniformizing element is movable between a plurality of positions along the optical path, the plurality of positions being associated to at least a top hat intensity distribution profile and one or more overcorrected intensity distribution profiles.
